(19) United States
(12) Patent Application Publication
(10) Pub. No.: US 2026/0257571 A1
(43) Pub. Date: Sep. 3, 2026

(54) ELECTRIC VEHICLE CHARGING SYSTEM

(71) Applicants: Francis O'Neill, Jupiter, FL (US); Anthony A. Hartzheim, Palm Beach Gardens, FL (US)

(72) Inventors: Francis O'Neill, Jupiter, FL (US); Anthony A. Hartzheim, Palm Beach Gardens, FL (US)

(21) Appl. No.: 19/066,324

(22) Filed: Feb. 28, 2025

(51) Int. Cl. B60L 53/30; B60L 53/18; B60L 53/57; F01D 15/10

(52) U.S. Cl. CPC B60L 53/30; B60L 53/18; B60L 53/57; F01D 15/10; F05D 2220/768

(57) ABSTRACT

An electric vehicle charging system includes a gas turbine engine having a compressor, a combustor downstream from the compressor, and a turbine downstream from the combustor. An electric generator is coaxially aligned with the compressor and includes a rotor coaxially aligned with the turbine. A shaft connects the turbine of the gas turbine engine to the rotor of said electric generator. A rectifier is operably connected to the electric generator, and a plurality of charging cables operably connected to the rectifier supply rectified power to the electric vehicle.

### FIELD OF THE INVENTION

The present invention generally involves an electric vehicle charging system. Particular embodiments of the electric vehicle charging system include a portable gas turbine, permanent magnet generator, and power electronics to supply direct current to simultaneously charge multiple electric vehicles.

### BACKGROUND OF THE INVENTION

The advent and increasing adoption of electric vehicles by consumers has resulted in a continual growth in the number of charging stations to provide a reliable source of power to recharge the electric vehicles. Each charging station generally supplies power from an existing electrical grid to individual charging stands for each electric vehicle. Although the charging stations are generally strategically located in areas of anticipated consumer demand, the increasing number of electric vehicles increasingly causes the demand for charging stations to exceed the available capacity of existing charging stations, resulting in charging delays and possibly stranding electric vehicles that could not receive a charge before being fully depleted. Temporary increases in consumer demand for charging stations, such as during weather events and other crises that require mass evacuations, further increase charging delays and the likelihood of stranding electric vehicles, particularly in rural areas separated from larger populations. Moreover, the very crises requiring mass evacuations may compromise or completely interrupt the power supply to existing charging stations, resulting in a reduction or complete loss of the ability of the charging stations to charge electric vehicles.

Mobile charging stations may provide additional charging capacity during temporary increases in consumer demand. The mobile charging stations may not only supplement existing charging stations for electric vehicles, but they also may be temporarily placed at rest stops, roadside parking areas, or other locations along evacuation routes to provide fast charging for multiple electric vehicles in a crisis. For example, a large battery placed on a trailer or other suitable transport vehicle may provide a mobile charging capacity that can be located where needed to supplement existing charging stations. Power from the battery may be supplied directly to the electric vehicles without the need for individual charging stands. However, a battery-powered mobile charging station necessarily has a limited capacity before being depleted, and the ability to recharge the battery, if even available during a crisis, presents additional logistical hurdles.

Another possible solution is to mobilize a generator powered by a combustion engine. However, a combustion-powered generator having a sufficient capacity to meaningfully supplement existing charging stations would require substantial logistical support. For example, the weight of a combustion-powered generator capable of generating at least 1 megawatt of power would easily exceed 30,000 pounds, requiring a trailer or other suitable transport vehicle capable of handling this weight. In addition, the combustion-powered generator would require individual charging stands for each electric vehicle and electrical cables to transfer the generated power from the generator to the charging stands.

Therefore, the need exists for a power generation system that can conveniently and reliably provide a portable source of power for charging electric vehicles.

### BRIEF DESCRIPTION OF THE INVENTION

Aspects and advantages of the invention are set forth below in the following description, or may be obvious from the description, or may be learned through practice of the invention.

One embodiment of the present invention is an electric vehicle charging system that includes a gas turbine engine having a compressor, a combustor downstream from the compressor, and a turbine downstream from the combustor. An electric generator is coaxially aligned with the compressor and includes a rotor coaxially aligned with the turbine. A shaft connects the turbine of the gas turbine engine to the rotor of said electric generator. A rectifier is operably connected to the electric generator, and a plurality of charging cables operably connected to the rectifier supply rectified power to the electric vehicle.

An alternate embodiment of the present invention is an electric vehicle charging system that includes a gas turbine engine having a compressor, a combustor downstream from the compressor, and a turbine downstream from the combustor. An electric generator is coaxially aligned with the compressor and includes a rotor that rotates at the same speed as the turbine. A plurality of charging cables operably connected to the electric generator supply power to the electric vehicle.

In yet another embodiment of the present invention, an electric vehicle charging system includes a gas turbine engine having a compressor, a combustor downstream from the compressor, and a turbine downstream from the combustor. An electric generator is coaxially aligned with the compressor and the turbine. A rectifier is operably connected to the electric generator, and a plurality of charging cables operably connected to the rectifier supply rectified power to the electric vehicle.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of an electric vehicle charging system according to one embodiment of the present invention;

FIG. 2 is side cross-section view of the gas turbine engine and electric generator shown in FIG. 1 according to one embodiment of the present invention;

FIG. 3 is an enlarged front perspective cross-section view of the electric generator shown in FIG. 2;

FIG. 4 is an axial cross-section view of the rotor of the electric generator taken along line A-A of FIG. 3 according to one embodiment of the present invention;

FIG. 5 is an axial cross-section view of the rotor of the electric generator taken along line A-A of FIG. 3 according to an alternate embodiment of the present invention;

FIG. 6 is an axial cross-section view of the rotor of the electric generator taken along line A-A of FIG. 3 according to an alternate embodiment of the present invention;

FIG. 7 is an axial cross-section view of the rotor of the electric generator taken along line A-A of FIG. 3 according to an alternate embodiment of the present invention; and

FIG. 8 is a functional block diagram of the power electronics for the electric vehicle charging system according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, the terms “upstream” and “downstream” refer to the location of items with reference to the direction of fluid flow in a fluid pathway. For example, item A is “upstream” from item B and item B is downstream from item A if fluid normally flows from item A to item B. As used herein, “axial” refers to the direction of the longer axis of a component, “radial” refers to the direction perpendicular to the axial direction, and “circumferential” refers to the direction around a component. As used in the claims, the definite article “said” identifies required elements that define the scope of embodiments of the claimed invention. In contrast, the definite article “the” merely identifies environmental elements that provide context for embodiments of the claimed invention that are not intended to be a limitation of any claim.

Embodiments of the present invention include an electric vehicle charging system that can provide 1 MW, 1.5 MW, 2 MW, or more of electric power to simultaneously charge over a dozen electric vehicles. The electric vehicle charging system may be permanently installed and/or portable to supply electric power where needed in geographically remote areas or following a natural disaster. Particular embodiments of the present invention may include additional design features to reduce the weight, manufacturing cost, and/or maintenance associated with the electric vehicle charging system. For example, particular embodiments may use a single-spool gas turbine engine to drive a coaxially located electric generator to substantially reduce the weight of the electric vehicle charging system. As used herein, a “single-spool gas turbine engine” means a gas turbine engine in which a single spool or shaft, which may include multiple segments, connects the turbine to the compressor so that the turbine and compressor rotate at the same speed. The single spool or shaft may also connect the gas turbine engine to a rotor of the electric generator so that the compressor, turbine, and rotor of the electric generator rotate at the same speed. The use of a single spool or shaft reduces the weight and parts associated with the gas turbine engine, simplifying manufacture, maintenance, and repairs compared to multi-spool systems having a gear box. The reduced weight associated with a single-spool gas turbine engine reduces the need for a separate lube oil system to lubricate and cool the rotating components of the gas turbine engine. As a result, in particular embodiments the gas turbine engine may include non-lubricated bearings and/or an integrally bladed rotor that further reduce manufacturing, maintenance, and repair costs. As used herein, “non-lubricated bearings” means that the bearings are not supplied external lubrication, such as from a lube oil system, during operation of the gas turbine engine.

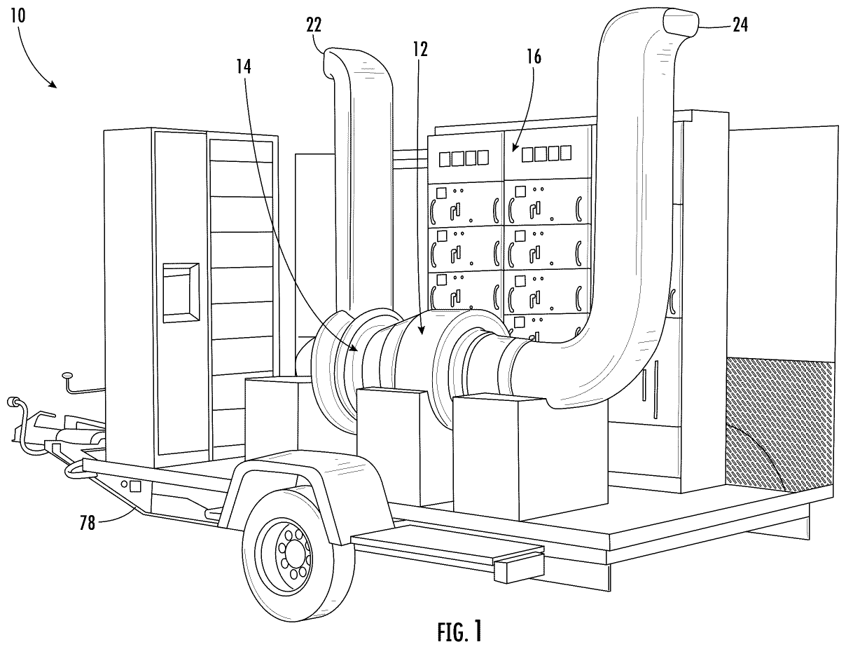

FIG. 1 provides a perspective view of an electric vehicle charging system 10 according to one embodiment of the present invention. As shown in FIG. 1, the electric vehicle charging system 10 generally includes a gas turbine engine 12, an electric generator 14, and power electronics 16. The gas turbine engine 12 directly connects to the electric generator 14 to produce the desired electrical power of 1 MW, 1.5 MW, 2 MW, or more. The power electronics 16 convert the produced electrical power to suitable voltage and current for simultaneously charging multiple electric vehicles.

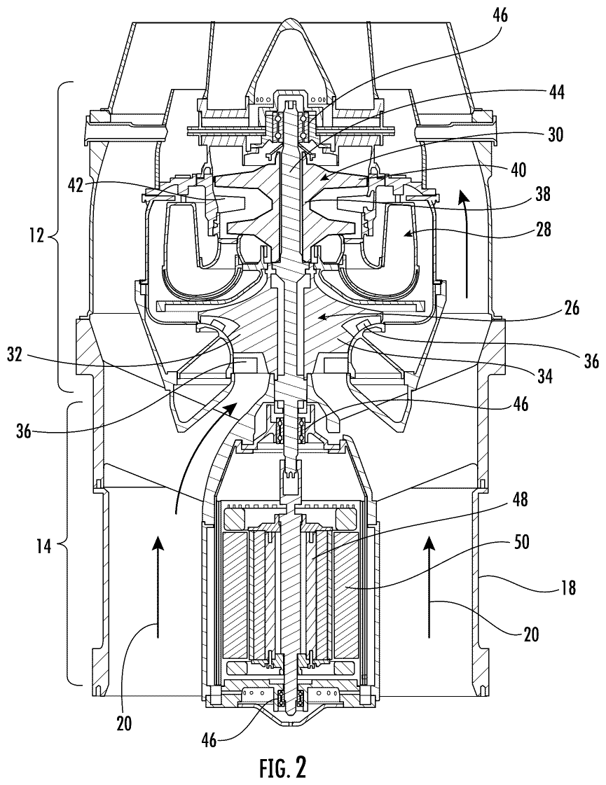

FIG. 2 provides a side cross-section view of the gas turbine engine 12 and electric generator 14 shown in FIG. 1 according to one embodiment of the present invention. As shown in FIGS. 1 and 2, a shroud 18 may surround the gas turbine engine 12 and electric generator 14 to define a fluid flow path 20 to and around the gas turbine engine 12. An inlet 22 may supply a working fluid through the fluid flow path 20 to the gas turbine engine 12 for combustion and subsequent exhaust through an outlet 24.

The gas turbine engine 12 generally includes a compressor 26, combustors 28 downstream from the compressor 26, and a turbine 30 downstream from the combustors 28, as is known in the art. The compressor 26 includes a rotor 32 with one or more alternating stages of rotating blades 34 and fixed vanes 36 that progressively increase the pressure of the working fluid flowing through the compressor 26. The combustors 28 mix the compressed working fluid with fuel and ignite the mixture to generate combustion gases having a high temperature, pressure, and velocity. The turbine 30 includes a rotor 38 with one or more alternating stages of rotating blades 40 and fixed vanes 42 to extract work from the combustion gases exiting the combustors 28. In the particular embodiment shown in FIG. 2, the compressor 26 is a single stage, axial-flow compressor, and the turbine 30 is a two-stage axial-flow turbine. However, unless specifically recited in the claims, the gas turbine engine 12 included in the present invention is not limited to any particular design or size and may include a multi-stage axial or radial-flow compressor 26, one or more combustors 28, and an axial or radial-flow turbine 30 with one or more stages.

Gas turbine engines are generally more efficient at higher turbine inlet temperatures which may damage the rotating blades in the turbine. As a result, the rotating blades are often hollow so that cooling may be supplied through the rotor to the hollow rotating blades to prevent damage from the higher turbine inlet temperatures. In the particular embodiment shown in FIG. 2, the gas turbine engine 12 is designed to operate at lower turbine inlet temperatures than what may otherwise be preferred to achieve a desired efficiency for the gas turbine engine 12. The lower turbine inlet temperatures in turn reduce the need for internal cooling to the rotating blades 40 in the turbine 30. As a result, in particular embodiments of the present invention, the rotor 38 in the turbine 30 may be an integrally bladed rotor 38 or “blisk” in which the rotating blades 40 are solid and integrally formed as a solid piece with the rotor 38. The integrally bladed rotor 38 may be manufactured by additive printing, casting, machining from a solid piece of material, or welding individual blades 40 to the rotor 38, as is known in the art. The resulting integrally bladed rotor 38 reduces the complexity, weight, and cost of manufacturing and assembly by avoiding the intricacy of hollow blades, dovetail connections to the rotor, and forced cooling through the rotor and blades.

The gas turbine engine 12 may include one or more spools or shafts that rotationally couple the turbine 30 to the compressor 26, as is known in the art. In a multi-spool gas turbine engine, for example, the compressor and the turbine may each include a high pressure section and a low pressure section, and a first spool may connect the high pressure section of the turbine to the high pressure section of the compressor, while a second spool may connect the low pressure section of the turbine to the low pressure section of the compressor. In this manner, each turbine section drives the corresponding compressor section with a separate spool, with one spool inside the other spool. In the particular embodiment shown in FIG. 2, the gas turbine engine 12 is a single-spool gas turbine engine 12 in which a single spool or shaft 44 connects the turbine 30 to the compressor 26 so that the turbine rotor 38 and the compressor rotor 32 rotate at the same speed. The single spool or shaft 44 may include multiple segments connected together to rotate in unison and transmit rotation of the turbine rotor 38 directly to the compressor rotor 32 without the use of gears. The use of a single spool or shaft 44 reduces the weight and parts associated with the gas turbine engine 12, simplifying manufacture, maintenance, and repairs compared to multi-spool and/or geared systems. In addition, the reduced weight associated with the single-spool gas turbine engine 12 reduces the need for a separate lube oil system to lubricate and cool the rotating components of the gas turbine engine 12.

The single-spool gas turbine engine 12 shown in FIG. 2 is lighter and generates less heat compared to a similarly sized gas turbine engine with multiple spools or shafts and/or gears. As a result, bearings that support the rotating components of the gas turbine engine 12 do not require an external source of lube oil to lubricate and cool the bearings, and particular embodiments of the present invention may include non-lubricated bearings 46 that rotatably support the shaft 44 or single-spool gas turbine engine 12. As shown most clearly in FIG. 2, for example, the non-lubricated bearings 46 may support the single spool or shaft 44 at various positions in the gas turbine engine 12 and/or electric generator 14. As used herein, “non-lubricated bearings” means that the bearings are not supplied external lubrication, such as from a lube oil system, during operation of the gas turbine engine. The non-lubricated bearings 46 may include, for example, air-lubricated bearings or ceramic bearings encapsulated in a casing that allows periodic addition of lubrication to the bearings without the ability to permit lube oil flow through the bearings during operation. The non-lubricated bearings 46 thus further reduce the weight, manufacturing cost, maintenance cost, and complexity of the gas turbine engine 12 by obviating the need for a separate lube oil system and associated pumps, sumps, and filters.

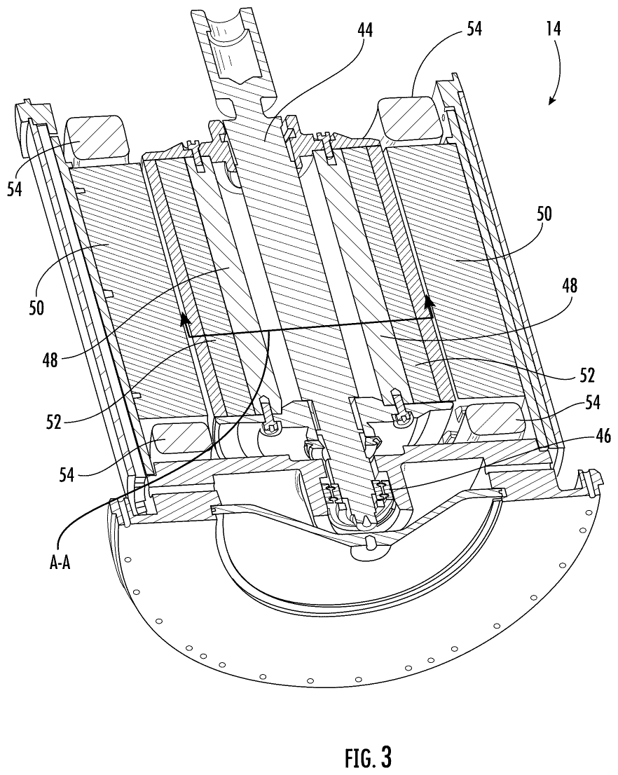

FIG. 3 provides an enlarged front perspective cross-section view of the electric generator 14 shown in FIGS. 1 and 2. The electric generator 14 generally includes a rotor 48 and a stator 50, and relative movement between the rotor 48 and the stator 50 disrupts a magnetic field between the two to convert mechanical energy into electrical energy, as is known in the art. In the particular embodiment shown in FIGS. 2 and 3, the rotor 48 includes permanent magnets 52 that create the magnetic field, and the stator 50 includes conductive windings 54 so that relative movement between the permanent magnets 52 on the rotor 48 and the conductive windings 54 on the stator 50 disrupts the magnetic field and induces current flow in the conductive windings 54. One of ordinary skill in the art will readily appreciate that the magnetic field may be created by a current applied to the rotor 48 instead of permanent magnets, or the stator 50 may generate the magnetic field, and the rotor 48 may include the conductive windings 54, and the present invention is not limited to the particular configuration of the electric generator 14 unless specifically recited in the claims.

The electric generator 14 may be located outside of the shroud 18 or remote from the fluid flow path 20, and the present invention is not limited to a particular location for the electric generator 14 unless specifically recited in the claims. In the particular embodiment shown in FIGS. 1-3, the electric generator 14 is located in the fluid flow path 20 upstream from the gas turbine engine 12. In addition, the rotor 48 of the electric generator 14 is coaxially aligned with the compressor 26, the turbine 30, and the turbine rotor 38 to avoid the need for gears or universal joints that would otherwise be needed to transfer rotational work from the gas turbine engine 12 to the electric generator 14.

The use of a gas turbine engine to drive an electric generator is known in the art. For example, U.S. Pat. No. 6,962,057 describes a micro gas turbine in which a single-spool gas turbine engine drives a coaxially aligned electric generator to produce 20-100 kW of power. The power output of the electric generator may be increased by increasing the strength of the magnetic field, e.g., by incorporating larger permanent magnets on the rotor. However, the additional mass associated with larger permanent magnets produces larger centrifugal forces that tend to separate the permanent magnets from the rotor, particularly at the high rotational speeds associated with a single-spool gas turbine engine that directly drives the electric generator. Therefore, gas turbine engines that drive higher power output generators generally require multiple spools or shafts, gears, and/or transmissions that allow the rotor of the electric generator to rotate at substantially lower speeds than the turbine in the gas turbine engine to prevent the centrifugal forces from separating the permanent magnets from the rotor.

In the particular embodiment shown in FIGS. 1-3, the single spool or shaft 44 connects the turbine rotor 38 to the rotor 48 of the electric generator 14 so that the turbine rotor 38 and the generator rotor 48 rotate at the same speed. Although the output power of the electric generator 14 is not a limitation of the present invention unless recited in the claims, in particular embodiments, the electric generator 14 may produce an output of greater than 1 MW, 1.5 MW, or 2 MW. Inasmuch as the turbine rotor 38 may rotate at 20,000 rpm or more, the incorporation of larger permanent magnets 52 on the rotor 48 to produce output power greater than 1 MW requires additional structure to hold the permanent magnets 52 in place. Therefore, the electric generator 14 may further include means for holding the permanent magnets 52 in place on the rotor 48 during operation of the gas turbine engine 12, the turbine 30, and/or the turbine rotor 38.

The function of the means for holding the permanent magnets 52 in place on the rotor 48 during operation of the gas turbine engine 12, the turbine 30, and/or the turbine rotor 38 is to prevent movement between the rotor 48 and the permanent magnets 52 during operations. The structure for performing this function may be any mechanical coupling with the permanent magnets 52 that prevents the permanent magnets 52 from moving with respect to the rotor 48. For example, the mechanical coupling may be one or more clamps, bolts, screws, or dovetail fittings that mechanically couple some or all of the permanent magnets 52 to the rotor 48. Alternately, the mechanical coupling may be a series of rails or other projections that extend radially from the rotor 48 combined with an overwrap that circumferentially surrounds the permanent magnets 52. The rails or other projections engage with some or all of the permanent magnets 52 to transfer torque between the rotor 48 and the permanent magnets 52 and prevent the permanent magnets 52 from moving circumferentially with respect to the rotor 48. In particular embodiments, the rails or other projections may be contoured, ribbed, tapered, or flanged to match a complementary recess in the permanent magnets 52. The overwrap that circumferentially surrounds the permanent magnets 52 provides sufficient centripetal force against the permanent magnets 52 to offset the centrifugal forces caused by rotation of the rotor 48 to prevent the permanent magnets 52 from moving radially away from the rotor 48. The overwrap may be a fiber or composite material sprayed or wrapped around the outer circumference of the permanent magnets 52. In combination, the rails or projections and overwrap thus securely hold the permanent magnets 52 in contact with the rotor 48 to prevent circumferential and radial movement between the rotor 48 and the permanent magnets 52 during operations.

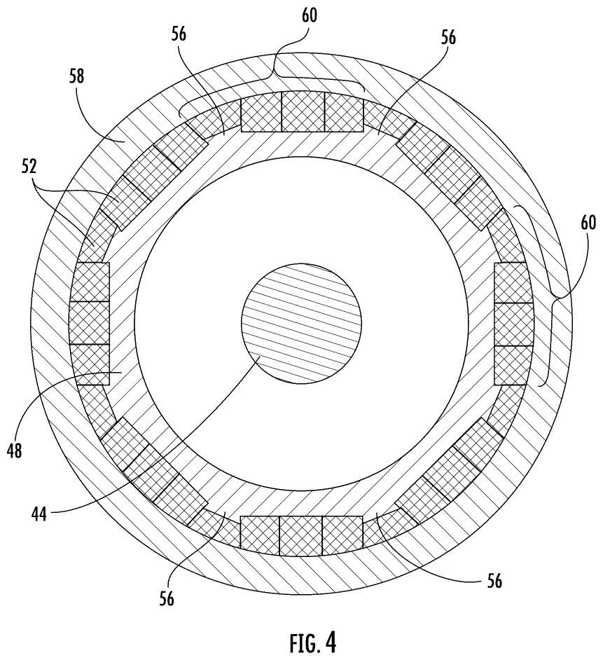

FIG. 4 provides an axial cross-section view of the rotor 48 of the electric generator 14 taken along line A-A of FIG. 3 according to one embodiment of the present invention. In this particular embodiment, the permanent magnets 52 are arranged circumferentially around the rotor 48 and extend longitudinally along the rotor 48 to create the magnetic field. The means for holding the permanent magnets 52 in place on the rotor 48 during operation of the gas turbine engine 12, the turbine 30, and/or the turbine rotor 38 includes multiple rails 56 and an overwrap 58. The multiple rails 56 extend radially from the rotor 48 and may extend longitudinally along some or all of the rotor 48. As shown in FIG. 4, the permanent magnets 52 are arranged in repeating groups 60 of four magnets 52, and the outer surface of the rotor 48 in contact with the permanent magnets 52 is substantially flat. Three permanent magnets 52 in each group 60 are sandwiched between or engaged with adjacent rails 56, and one permanent magnet 52 in each group 60 has a shorter radial dimension and is on top of a rail 56. In this manner, the rails 56 provide the mechanical coupling between the rotor 48 and the permanent magnets 52 to transfer torque between the rotor 48 and the permanent magnets 52 and prevent the permanent magnets 52 from moving circumferentially with respect to the rotor 48. The overwrap 58 circumferentially surrounds the permanent magnets 52 to provide sufficient centripetal force against the permanent magnets 52 to offset the centrifugal forces caused by rotation of the rotor 48 to prevent the permanent magnets 52 from moving radially away from the rotor 48. The rails 56 and overwrap 58 thus combine to provide the structure for holding the permanent magnets 52 in place on the rotor 48 during operation of the gas turbine engine 12, the turbine 30, and/or the turbine rotor 38.

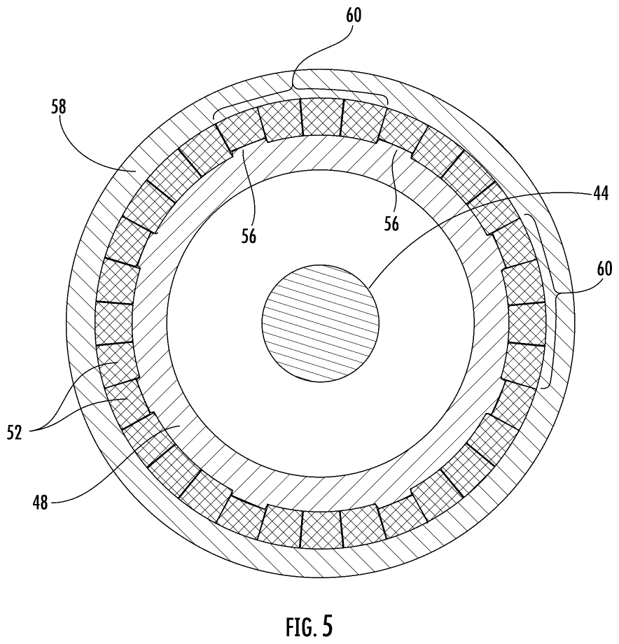

FIG. 5 provides an axial cross-section view of the rotor 48 of the electric generator 14 taken along line A-A of FIG. 3 according to an alternate embodiment of the present invention. As shown in FIG. 5, the permanent magnets 52 are again arranged circumferentially around the rotor 48 and extend longitudinally along the rotor 48 to create the magnetic field, and the means for holding the permanent magnets 52 in place on the rotor 48 during operation of the gas turbine engine 12, the turbine 30, and/or the turbine rotor 38 again includes multiple rails 56 and an overwrap 58 as described with respect to FIG. 4. The permanent magnets 52 are again arranged in eight repeating groups 60 of four magnets 52. In this particular embodiment, however, the outer surface of the rotor 48 in contact with the permanent magnets 52 is curved, with the magnitude of the curve based on the radius of the rotor 48. As a result, this particular embodiment only requires fabrication of two different magnet sizes. Specifically, the three permanent magnets 52 in each group 60 that are sandwiched between or engaged with adjacent rails 56 are identical to one another, and the permanent magnet 52 in each group 60 on top of a rail 56 differs only in its radial dimension. The use of substantially identical permanent magnets 52 simplifies construction by reducing the manufacturing and maintenance costs associated with the permanent magnets 52.

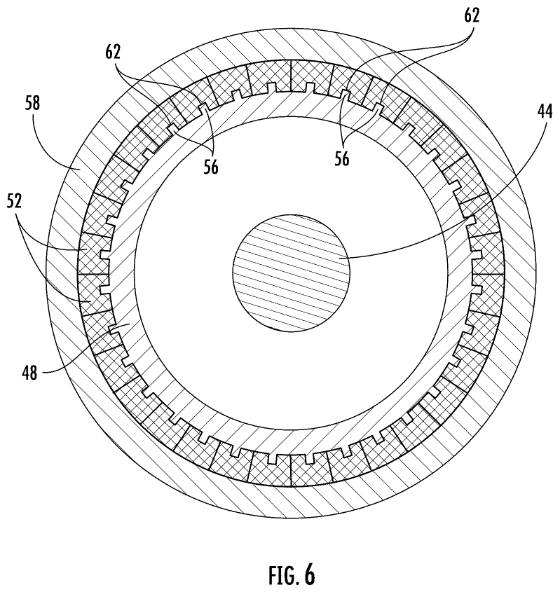

FIG. 6 provides an axial cross-section view of the rotor 48 of the electric generator 14 taken along line A-A of FIG. 3 according to an alternate embodiment of the present invention. As shown in FIG. 6, the permanent magnets 52 are again arranged circumferentially around the rotor 48 and extend longitudinally along the rotor 48 to create the magnetic field, and the means for holding the permanent magnets 52 in place on the rotor 48 during operation of the gas turbine engine 12, the turbine 30, and/or the turbine rotor 38 again includes multiple rails 56 and an overwrap 58 as described with respect to FIG. 4. In this particular embodiment, the means further includes a recess 62 in some or all of the permanent magnets 52. Each recess 62 may have a shape that is complementary to the shape of the rails 56 to allow each rail 56 to extend into a recess 62 of a different permanent magnet 52. The mechanical coupling between the rails 56 and recesses 62 prevents the permanent magnets 52 from moving circumferentially with respect to the rotor 48, and the overwrap 58 prevents the permanent magnets 52 from moving radially away from the rotor 48. The rails 56, recesses 62, and overwrap 58 thus combine to provide the structure for holding the permanent magnets 52 in place on the rotor 48 during operation of the gas turbine engine 12, the turbine 30, and/or the turbine rotor 38.

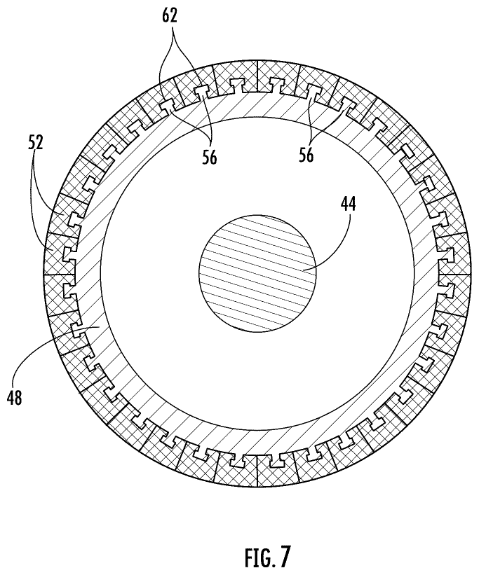

FIG. 7 provides an axial cross-section view of the rotor 48 of the electric generator 14 taken along line A-A of FIG. 3 according to an alternate embodiment of the present invention. As shown in FIG. 7, the means for holding the permanent magnets 52 in place on the rotor 48 during operation of the gas turbine engine 12, the turbine 30, and/or the turbine rotor 38 again includes multiple rails 56 and recesses 62 in the permanent magnets 52. In this particular embodiment, the rails 56 are T-shaped, and the recesses 62 in the permanent magnets 52 have a complementary shape to receive the T-shaped rails 56. The rails 56 and recesses 62 thus provide the mechanical coupling that prevents the permanent magnets 52 from moving both circumferentially and radially with respect to the rotor 48, and an overwrap is not needed in this embodiment to perform the function of holding the permanent magnets 52 in place on the rotor 48 during operation of the gas turbine engine 12, the turbine 30, and/or the turbine rotor 38. One of ordinary skill in the art will readily appreciate that other shapes for the rails 56 and recesses 62 would similarly perform the function of holding the permanent magnets 52 in place on the rotor 48 during operation of the gas turbine engine 12, the turbine 30, and/or the turbine rotor 38 without the need for an overwrap. For example, alternate embodiments of the present invention may include rails 56 and recesses 62 having a fir tree shape, an L-shape, a dovetail shape, etc., and the present invention is not limited to any particular shape for the rails 56 and recesses 62 unless specifically recited in the claims.

The embodiments shown in FIGS. 4-7 thus allow larger and heavier permanent magnets 52 to be incorporated into the electric generator 14 to increase the output power of the electric generator 14. For example, embodiments in which the single spool or shaft 44 rotates the rotor 48 of the electric generator 14 at the same speed as the turbine rotor 38 may generate an output of more than 1 MW, 1.5 MW, or even 2 MW, depending on the radius of the rotor 48 and the size of the permanent magnets 52. This substantial output power may be used for any purpose, such as providing a portable power supply to remote geographic areas or following weather-related catastrophes.

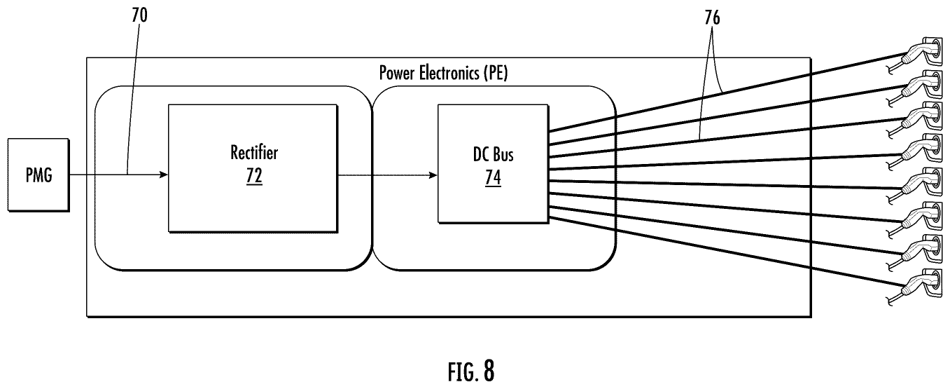

FIG. 8 provides a functional block diagram of the power electronics 16 for the electric vehicle charging system 10 according to one embodiment of the present invention. As shown in FIG. 8, the electric generator 14 produces a high frequency, alternating current output 70. A rectifier 72 operably connected to the electric generator 14 rectifies the output from the electric generator 14 to produce a high voltage, direct current power to a DC bus 74. A plurality of charging cables 76 may then supply the rectified power directly to electric vehicles for charging without the need for further rectifying. In this manner, the plurality of charging cables 76 directly connect the rectifier 72 to the electric vehicles without the need for separate rectifiers or charging stations as conventionally required.

It is anticipated that the electric vehicle charging system 10 shown in FIG. 1, including the charging cables 76 shown in FIG. 8, will weigh approximately three tons and can be housed inside a 12×8×8 foot enclosure which is substantially lighter and smaller than a conventional charging system that relies on either a large battery or internal combustion engine to power a generator and which also requires individual charging stations and cables. As a result, the electric vehicle charging system 10 may further include a means for transporting the electric vehicle charging system 10. The function of the means for transporting the electric vehicle charging system 10 is to transport the electric vehicle charging system 10 to desired locations when needed. The structure for performing this function may be a shipping container, truck, bus, or conventional trailer that can accommodate the weight of the electric vehicle charging system 10. As shown in FIG. 1, for example, a trailer 78 with air bladder springs may provide a stable platform for transporting various embodiments of the present invention as desired.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

1. An electric vehicle charging system, comprising:
a gas turbine engine, wherein said gas turbine engine comprises a compressor, a combustor downstream from said compressor, and a turbine downstream from said combustor;
an electric generator coaxially aligned with said compressor, wherein said electric generator comprises a rotor coaxially aligned with said turbine;
a shaft that connects said turbine of said gas turbine engine to said rotor of said electric generator;
a rectifier operably connected to said electric generator; and
a plurality of charging cables operably connected to said rectifier to supply rectified power to the electric vehicle.

2. The electric vehicle charging system as in claim 1, wherein said plurality of charging cables directly connect said rectifier to the electric vehicle.

3. The electric vehicle charging system as in claim 1, further comprising a means for transporting said electric vehicle charging system.

4. The electric vehicle charging system as in claim 1, wherein said turbine and said rotor of said electric generator rotate at the same speed.

5. The electric vehicle charging system as in claim 1, wherein said gas turbine engine is a single-spool gas turbine engine.

6. The electric vehicle charging system as in claim 1, wherein said electric generator is upstream from said compressor.

7. The electric vehicle charging system as in claim 1, wherein said turbine comprises an integrally bladed rotor.

8. The electric vehicle charging system as in claim 1, further comprising a plurality of non-lubricated bearings that rotatably support said shaft.

9. An electric vehicle charging system, comprising:
a gas turbine engine, wherein said gas turbine engine comprises a compressor, a combustor downstream from said compressor, and a turbine downstream from said combustor;
an electric generator coaxially aligned with said compressor, wherein said electric generator comprises a rotor that rotates at the same speed as said turbine; and
a plurality of charging cables operably connected to said electric generator to supply power to the electric vehicle.

10. The electric vehicle charging system as in claim 9, further comprising a rectifier operably connected to said electric generator, and said plurality of charging cables directly connect said rectifier to the electric vehicle.

11. The electric vehicle charging system as in claim 9, further comprising a means for transporting said electric vehicle charging system.

12. The electric vehicle charging system as in claim 9, wherein said gas turbine engine is a single-spool gas turbine engine.

13. The electric vehicle charging system as in claim 9, wherein said electric generator is upstream from said compressor.

14. The electric vehicle charging system as in claim 9, wherein said turbine comprises an integrally bladed rotor.

15. The electric vehicle charging system as in claim 9, further comprising a plurality of non-lubricated bearings that rotatably support said turbine.

16. An electric vehicle charging system, comprising:
a gas turbine engine, wherein said gas turbine engine comprises a compressor, a combustor downstream from said compressor, and a turbine downstream from said combustor;
an electric generator coaxially aligned with said compressor and said turbine;
a rectifier operably connected to said electric generator; and
a plurality of charging cables operably connected to said rectifier to supply rectified power to the electric vehicle.

17. The electric vehicle charging system as in claim 16, further comprising a means for transporting said electric vehicle charging system.

18. The electric vehicle charging system as in claim 16, wherein said turbine comprises an integrally bladed rotor.

19. The electric vehicle charging system as in claim 16, wherein said turbine and said rotor of said electric generator rotate at the same speed.

20. The electric vehicle charging system as in claim 16, further comprising a plurality of non-lubricated bearings that rotatably support said turbine.
